(19) United States
(12) Patent Application Publication
(10) Pub. No.: US 2008/0245777 A1
(43) Pub. Date: Oct. 9, 2008

(54) Laser Welding of Hardenable Steel

(76) Inventors: Rolf Cremerius, St. Augustin (DE); Thomas Pullen, Aachen (DE)

Correspondence Address: Dickinson Wright PLLC, 38525 Woodward Avenue, Suite 2000, Bloomfield Hills, MI, 48304, US

(21) Appl. No.: 10/562,856

(22) PCT Filed: Sep. 10, 2004
(86) PCT No.: PCT/EP04/10120

§ 371 Date: May 19, 2008

(51) Int. Cl. B23K 26/02

(52) U.S. Cl. 219/121.64

(57) ABSTRACT

Process for producing a weld seam (1) in hardenable steel, comprising at least the following steps:
a) positioning a laser beam (2) with respect to a weld line (3);
b) heating subregions (4) of the steel by means of the laser beam (2), with the laser beam (2) being guided along a welding track (5) which is longer than the weld line (3);
c) cooling the heated subregions (4) of the steel.
   This welding process produces crack-free welded joins without the need for secondary heating of the hardenable steel. A preferred application area for weld seams of this type is to join components of the drive train of automobiles.

The invention relates to a process for producing a weld seam with respect to hardenable steel, this weld seam preferably being used to form a join between at least two components for torque transmission.

The use of beam welding for machine components made from hardenable steels is already known. Objects for which their use is possible and expedient include all components which can be joined by beam welding processes, are subject to high mechanical, cyclical or dynamic stresses and which at least partially comprise hardenable steels on account of local welding stresses or are quenched and tempered on account of their high mechanical stresses. Beam welding processes can particularly advantageously also be used in connection with the production of a very wide range of, in particular rotationally symmetrical, force transmission elements, hollow bodies which are acted on by pressure, etc. A preferred application area is vehicle and mechanical engineering, in particular the automotive industry.

What are known as carbon steels with a carbon content of at least 0.25% and low alloy steels with a carbon content of over 0.2% are of only limited suitability for conventional welding (also referred to below as “hardenable steels”). The reason for this lies in the surface hardening in the weld seam and the heat-affected zone, which is caused by the carbon, is exacerbated by various alloying elements and leads to cracks. The surface hardening and subsequent formation of cracks comes about as a result of the formation of relatively undeformable martensite or bainite which has not undergone any self-tempering or has only undergone a small amount of self-tempering and is not capable of plastically breaking down the high transient stresses which occur during cooling.

Whereas conventional welding processes generally have a relatively low power density, leading to relatively low heating rates, large-area introduction of heat and bulky weld seams, this can be avoided by the use of a beam welding process, such as laser or electron beam welding, on account of the power density then being up to some orders of magnitude higher.

EP 0 925 140 B1 has disclosed a beam welding process for welding hardenable steels, in which in addition to the action of heat resulting from the beam welding itself, a defined preheating of the steel to be welded is additionally proposed. In particular, a short-time heat treatment is carried out as the only preheating. This becomes possible if the heating depth, the heat-up time, the peak temperature of the temperature/time cycle and the quenching rate are selected within tightly defined limits. The heating depth before the beam welding begins is in this case set in such a way as to be from 1 to 5 times the weld seam depth. The energy action duration itself, the induction power and induction frequency and to a small extent also the peak temperature of the preheating cycle are used as free parameters for setting the heating depth. Beam welding by means of laser is described as a preferred variant, with the preheating in this case being carried out inductively.

It is an object of the present invention to at least partially alleviate the technical problems which have been described in connection with the prior art. In particular, it is aimed to provide a laser welding process which allows hardenable steels to be processed in such a way that the formation of cracks resulting from the self-quenching of the steel at least occurs to a significantly reduced extent and is preferably even avoided altogether. The welding process is to be quick and simple to carry out and is to be such that in particular it can also easily be integrated in series production with short cycle times. Moreover, it is intended to provide a join between components for torque transmission made from hardenable steel, which is able to reliably transmit in particular torques or forces which occur in the drive train of an automobile.

These objects are achieved by a process in accordance with the features of Patent Claim 1 and a join produced in this way between at least two components for torque transmission. Further advantageous configurations of the invention are described in the dependent patent claims. It should be noted that the features listed individually in the patent claims can be combined with one another in any technologically suitable way to give further configurations of the invention.

The process according to the invention for producing a weld seam in hardenable steel comprises at least the following steps:
a) positioning a laser beam with respect to a weld line;
b) heating subregions of the steel by means of the laser beam, with the laser beam being guided along a welding track which is longer than the weld line;
c) cooling the heated subregions of the steel.

A “weld seam” is to be understood as meaning a resolidified region of the hardenable steel which has previously been brought into a molten state as a result of the action of heat from the arc. The weld seam may include further constituents, in particular if a filler is used to produce the weld seam.

The weld seam substantially follows a desired weld line. In other words, the term “weld line” is to be understood as meaning the final profile of the weld seam. Now, in accordance with step a), the laser which generates the laser beam or the laser beam is positioned or aligned with respect to the weld line. It is in this context irrelevant whether the laser is oriented with respect to the component or vice versa.

Next, the laser beam is generated and brought into contact with the hardenable steel. This heats the steel in the region of the point of impingement of the laser beam. The energy interaction or melting action depends in particular on the laser power, the residence time of the laser beam at a location (known as the welding speed or feed rate), the configuration of the laser beam (e.g. laser beam dimensions, focus radius, etc.) and the power density distribution at the workpiece. The shielding and working gases used and the way in which they are supplied also influence the formation of a plasma and therefore also the introduction of energy into the workpiece.

It is now proposed at this point that the laser beam be guided along a welding track which is longer than the weld line. The term “welding track” is to be understood as meaning in particular the path which the laser beam actually covers on the surface of the hardenable steel. In other words, this means that the energy per unit length required for welding is effected by lengthening the welding track.

The energy of the laser beam is preferably set in such a way that a deep-weld effect is produced. The intensity of the laser is therefore set in a range of greater than 10⁶ W/cm² (watts per square centimetre), in particular in a range from 1·10⁶ W/cm² to 2·10⁷ W/cm². Above this intensity, the absorbed laser radiation heats the material to such an extent that it melts and reaches the evaporation temperature. A vapour capillary is formed by a recoil pressure generated by the metal vapour flowing out at the phase transition. This capillary allows deep penetration of the laser radiation into the material. Depending on the vapour density and degree of ionization of the metal vapour, the energy of the laser radiation is preferentially absorbed at the molten film surface of the capillary and optionally also by inverse bremsstrahlung within the plasma and introduced into the material via heat conduction. An equilibrium state between the recoil pressure of the metal vapour and the dynamic pressure of the melt flow allows the capillary to be permanently maintained during the welding process. As a result, it is possible to achieve weld seam aspect ratios (ratio of depth to width of the weld seam) with values of significantly greater than 1, for example in a range from 1 to 4. The metal vapour which flows out of the vapour capillary is cooled by the use of a shielding gas, in order to minimize energy losses from the incident laser radiation by inverse bremstrahlung or refraction. The term “inverse bremsstrahlung” is to be understood as meaning the intensity loss of the laser radiation as it penetrates through the surface plasma on account of the acceleration of free electrons through absorption of photon energy. A CO₂ laser is preferably used to generate the laser beam.

On account of the fact that the laser beam covers a larger region than the actual weld line, the energy introduced per unit length is advantageously influenced in such a way that there is no need for preheating or secondary heating and yet it is possible to produce weld seams which are able to withstand the high dynamic stresses. The reasons for this are that the cooling rates of the melt in the weld seam flank can be reduced towards the centre of the weld seam, and the undesired effect of crack or pore formation is avoided. This then has the advantage, for example, that the formation of a weld seam of this type in hardenable steel with a carbon content of over 0.3% or even over 0.5% allows direct and fast welding in a production line, wherein on the one hand it is possible to make use of processing stations which are often already present and on the other hand time-consuming preheating or secondary heating is avoided.

The cooling of the heated subregions of the steel is generally carried out without the need for further technical measures in ambient air, although under certain circumstances it is also possible to provide a shielding gas in order to further boost the quality of the weld seam in particular with regard to the pore or crack formation.

According to a configuration of the process, step b) comprises a relative movement of the laser beam with respect to the weld line at a feed rate, this relative movement having a secondary movement superimposed on it. The relative movement of the laser beam with respect to the weld line can be generated as a result of a movement of the laser and/or of the component that is to be provided with the weld seam. In this context, the term “feed rate” is to be understood as meaning the velocity component of the relative movement in the direction of the weld line. If a round component is being provided with a weld seam, for example, with a stationary laser directed onto the rotating component, the feed rate of the relative movement is determined by the rotational speed of the component. This feed rate is generally constant throughout the entire welding process. However, it may also vary during a welding operation in the event of changing component geometries (e.g. different dissipation of heat, different material thickness, different weld seam thickness, etc.), in order to enable the energy per unit length to be set accordingly. The feed rate is in this case, for example, in a range from 0.5 m/min to 5.0 m/min [metres per minute].

In addition to this relative movement, a secondary movement is now also realized. In this case too, it is fundamentally irrelevant whether this is realized by the laser or the component, but it is preferable to use a process in which the secondary movement is executed by the laser beam. It is in this case possible to move the laser itself, which generates the laser beam, however it is in many cases a technically more simple option for the laser beam to be diverted, for example by the use of mirrors or the like, so that it executes the desired secondary movement.

It is in this context particularly advantageous if the secondary movement is an oscillating movement with respect to the weld line. The oscillating movement can be carried out in the direction of the weld line, but it is preferable to use an oscillating movement which is executed obliquely or transversely with respect to the weld line. An oscillating movement of this type enables greater thermal energy to be introduced in the edge region of the weld seam (for example on account of the inertia of an oscillating mirror which diverts the laser beam at the turning points), with the result that the cooling rates are reduced in the edge region of the weld seam in the hardenable steel. As a result, the formation of cracks is also reduced to a considerable extent.

Moreover, it is also proposed that the secondary movement be varied while the weld seam is being formed. The secondary movement can be described, for example, with an amplitude, a centre position, a frequency, etc. On account of the possibility of precisely these parameters being varied at least in part and optionally from time to time while the weld seam is being formed, it is possible to react to the component-based mass ratios, heat conduction, etc. in the vicinity of the weld seam. It is then in turn possible to set targeted cooling of the hardenable steel in the region of the weld seam.

Furthermore, a lateral movement of the beam axis perpendicular for the weld line is also possible when forming a radial-circumferential welding track. The term lateral movement is to be understood as meaning in particular a component of the relative movement which, in the case described here, is consequently composed of a movement component in the circumferential direction and a movement component in the lateral direction. This leads, for example, to a helical configuration of the weld seam in the case of a round workpiece. The result is a second welding track without interruption directly next to the first one. This forms a smooth transition with an overlapping weld which, adapted to the prevailing mass ratios and material-specific thermal conductivities, leads to an increased energy per unit length and therefore to targeted cooling of the hardenable steel in the region of the weld seam.

Moreover, it is optionally also possible for the beam axis to be angled off, which is to be understood in particular as meaning that the laser beam does not impinge on the surface of the workpiece at right angles to it. The preferably acute angle between beam direction and weld line may be formed in the welding direction and/or transversely to it. This enables the laser radiation to impinge on the weld line in the direction of greater accumulations of mass or higher carbon contents of the component. The beam waist shape also changes from round to oval, with the result that the power density can be additionally adapted. Accordingly, energy is introduced, with the result that the cooling rates in the critical component regions can be reduced further.

According to another configuration of the process, the laser beam penetrates through the hardenable steel at least from time to time. This preferably constitutes what is known as penetration welding or keyhole welding. Components which have a wall thickness, for example, in the range from 2.0 to 10.0 mm are suitable for this application.

Moreover, it is proposed that the weld seam be produced with a width of at least 1.0 mm [millimetre]. It is preferable for the weld seam to have a width of at least 1.5 mm or even of at least 3.0 mm. This weld seam is thicker than standard laser weld seams, which is achieved, for example, on account of an oscillating movement transversely or obliquely with respect to the weld line. As a further alternative, it is possible to cover parallel welding tracks next to the weld line within a relatively short time in order to generate such a wide weld seam. The width of the weld seam is to be determined in particular in the vicinity of the surface of the steel from which the welding has been carried out. If welding which penetrates through the component has been carried out, the width on the remote side is in a range which under certain circumstances may be considerably smaller than the width referred to above.

According to another configuration of the process, the weld seam is produced for the purpose of joining at least two components. In this way, therefore, it is possible to produce cohesive joins between a plurality of components made from hardenable steel which are able to withstand even high fluctuating dynamic stresses. It is in this case possible for the two components to comprise steels which are different but both hardenable. It is also possible, for example, for just one of the components to comprise a hardenable steel. In this case, by way of example, it is possible to use the range of variations for the secondary movement to compensate for different thermal properties of the components that are to be joined.

It is also advantageous for the weld seam to be produced by radial circumferential welding. This is to be understood as meaning a welding process in which, in the case of hollow profiled sections, a weld seam which is continuous over the circumference is produced. The laser is in this case moved in the radial direction around the component or components. A process of this type is recommended, for example, for the end-side joining of hollow shafts or similar components.

The invention now also proposes a join between at least two components for torque transmission made from hardenable steel, the join comprising at least one weld seam produced by one of the processes according to the invention as mentioned above. The join between these two components can be used, for example, for torque transmission in drive systems of a car. This creates the possibility of the components subsequently also being fed to a hardening process, in order to withstand the in particular static stresses prevailing there.

A join of this type has proven advantageous in particular if at least one of the components is a hollow shaft with a wall thickness in the range from 2.0 to 10.0 mm. It is preferable for both components to have a structure resembling that of a hollow shaft in the region around the join. In this case, it is preferable for both the hollow shafts to have a wall thickness in this range, with an end-side join then being carried out.

Specifically in this context, it is advantageous for the weld seam to be formed over the entire wall thickness. In this case, a permanent join can be generated, for example, by keyhole welding by means of laser.

Furthermore, it is proposed that the join and adjoining subregions of the component be designed to be crack-free. The term “crack-free” is to be understood as meaning that the join does not include any macro-cracks, as they are known, i.e. cracks of a size which is such that they are visible to the naked eye. Smaller micro-cracks, as they are known (the length of these cracks is often only in the region of a grain diameter of the material, and they can only be perceived by microscopic (metallographic) methods) in this case also only occur to an acceptable extent. In the present context, a “crack” is in particular a limited material separation with a predominantly two-dimensional extent, which may occur in the weld metal, in the heat-affected zone and/or in the base metal, in particular on account of internal stresses. A “crack” needs to be distinguished, for example, from cavities, gas inclusions, pores, voids, solid inclusions and/or other defects in a weld seam. Although the defects in a weld seam which are distinct from cracks should of course also be avoided as far as possible, in the present context the primary objective is freedom from (macro-) cracks, since cracks are the most dangerous and widespread form of defect, making subsequent repair imperative. This has also hitherto been the reason why steels with a high carbon content have only been welded with secondary heating. The process according to the invention for the first time moves away from this conception yet nevertheless ensures a high weld quality over a large number of welding operations.

The weld seam formed in accordance with the invention in particular is able to withstand the following stresses:
dynamic long-term cyclic stressing of 300 000 oscillation cycles at a torque of ±1100 Nm and/or ±1650 Nm; and/or
static torsional stressing with a fracture torque of less than or equal to 3200 Nm.

In particular with a view to using a join of this type in the automotive industry, it is preferable for this join to have a ductility in the range from 250 HV to 650 HV, in particular in the range from 400 HV to 600 HV. This is to be understood as meaning that the join or weld seam leads to the abovementioned result in a Vickers hardness test method.

As has already been mentioned a number of times, the preferred use of the process and the join is in the automotive industry. For this reason, the invention also proposes a vehicle comprising an engine with a drive system, the drive system having components for torque transmission, and at least two components having been welded together by a process according to the invention, or the vehicle including a join according to the invention.

Example of a corresponding joining arrangement:

Process

| | |
|---|---|
| Material component A: | Ck 35 |
| | (carbon-containing |
| | case-hardening steel |
| | containing approx. 0.35% |
| | (percent by mass) of carbon) |
| Wall thickness component A: | 5.00 mm |
| Material component B: | Cf 53 |
| | (Quenched-and-temper steel |
| | containing approx. 0.53% of |
| | carbon) |
| Wall thickness component B: | 6.00 mm |
| Type of laser: | CO₂-laser |
| Laser intensity: | less than 3.33 · 10⁶ W/cm², in |
| | particular with a focussing |
| | mirror with a focal length |
| | F = 270.0 mm |
| Laser feed: | 1.6 m/min |
| Secondary movement: | Oscillation frequency of the |
| | focussing mirror of 30 Hz |
| | [1/second]; amplitude of |
| | 1.5 mm |
| Filler: | — |

Join

| | |
|---|---|
| Dimensions of the weld | Depth: approx. 6.0 mm |
| seam: | Width: approx. 3.0 mm |
| | Length: approx. 100.0 mm |
| Freedom from cracks | Yes |

The invention and the technical background are explained in more detail below with reference to figures. It should be noted that the figures show particularly preferred exemplary embodiments of the invention, but without the invention being restricted to these embodiments. In the drawing:

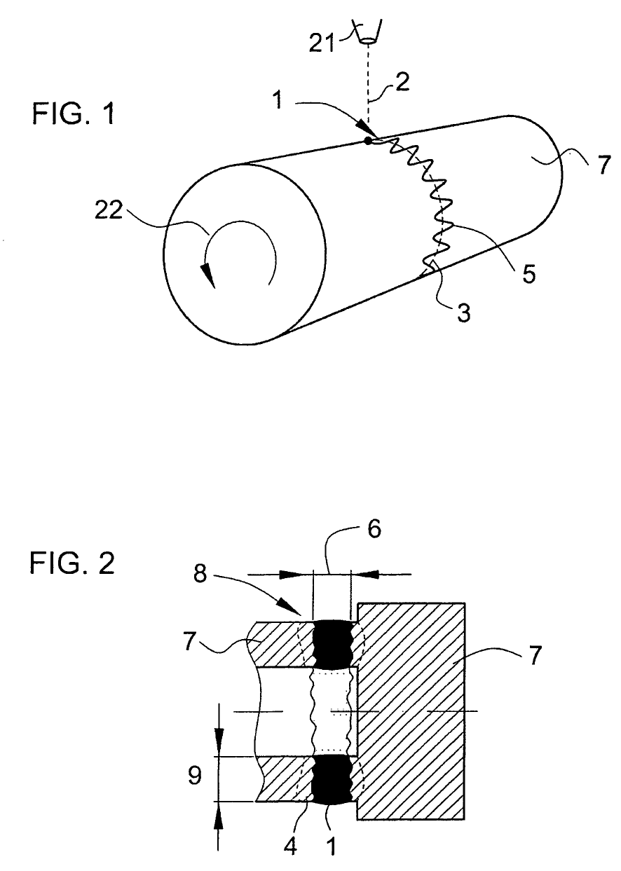

FIG. 1: diagrammatically depicts the structure of a variant embodiment of the welding process;

FIG. 2 shows a variant embodiment of the join in cross section through joined components;

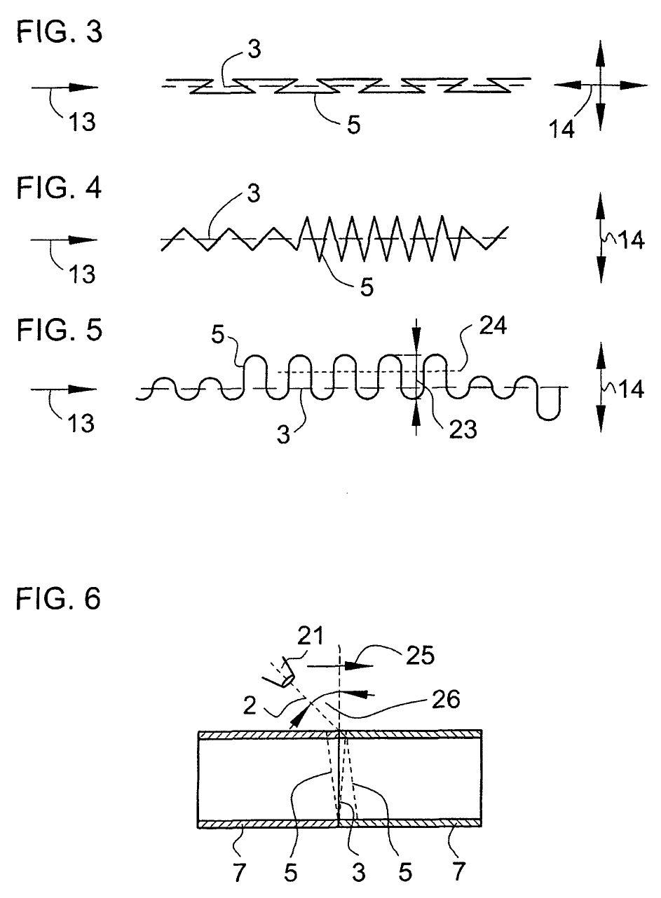

FIG. 3 shows a first variant embodiment of a welding track;

FIG. 4 shows a second variant embodiment of a welding track;

FIG. 5 shows a third variant embodiment of a welding track;

FIG. 6 shows a fourth variant embodiment of a welding track; and

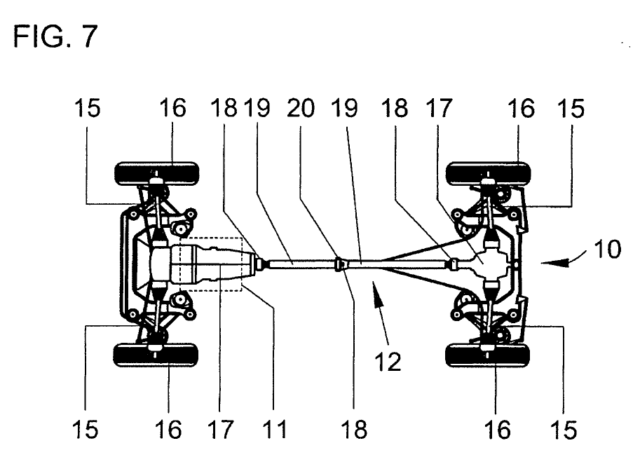

FIG. 7 diagrammatically depicts a drive system of a vehicle.

The illustrations in the drawings are diagrammatic and can only represent the actual proportions to a limited extent.

FIG. 1 shows a diagrammatic and perspective view of a component 7 with respect to which a weld seam 1 is being formed. To produce the weld seam 1 on the component 7, which comprises hardenable steel, first of all the laser beam 2 which emerges from the laser 21 is positioned with respect to the weld line 3. When the laser 2 is activated, subregions of the steel are heated by means of the laser beam 2. The component 7 is set in rotation 22 to generate a relative movement of the laser beam 2 with respect to the weld line 3. Then, to produce a crack-free weld seam 1, the laser beam 2 is guided along a welding track 5 which is longer than the weld line 3. Superimposing a secondary movement introduces the energy per unit length which is required for this purpose.

FIG. 2 diagrammatically depicts a cross section through a welded join 8 which has been produced by the process described. The join 8 is designed as a continuous weld seam 1 plus two components 7 arranged adjacent to one another. The component 7 illustrated on the left has a rotationally symmetrical hollow profile. The right-hand component 7 likewise has a tube-like portion which, however, merges into a solid end piece. Both components 7 comprise a hardenable steel. On account of the different dimensions of the components 7 adjacent to the weld seam 1, different thermal properties are also to be expected, which can be compensated for by the process described here.

To form the weld seam 1, the components 7 are heated in subregions 4 by a laser 2 (not illustrated) in such a way that the steel is at least partially converted into a molten state. The secondary movement allows a reduced cooling rate to be effective in the subregions 4, so that the formation of cracks is avoided. However, the secondary movement also leads to the generation of relatively large weld seams 1, for example with a width 6 in the range from 1.5 to 3.0 mm. In the variant embodiment illustrated here, the weld seam 1 was formed as a radial circumferential seam extending over the entire wall thickness 9 of the components 7.

FIG. 3 diagrammatically depicts the superimposing of the weld line 3 and the actual welding track 5. It should in principle be noted that despite the provision of a secondary movement, a uniform weld seam 1 running in the direction of the weld line 3 is formed. This weld seam 1 has a width 6 which is greater than that of standard weld seams on account of the action of a laser.

In the case of the secondary movement 14 illustrated in FIG. 3, both movements in the direction of the feed rate 13 and opposite and/or transversely to it are implemented.

FIG. 4 realizes the secondary movement 14 with a substantially one-dimensional oscillating movement perpendicular to the feed rate 13. However, a variation is achieved by virtue of the feed rate 13 and/or the amplitudes 23 of the secondary movement 14 being altered. This makes it possible to react to different thermal properties of the components 7 in the region of the weld seam 1.

FIG. 5 in turn illustrates a secondary movement 14 which is executed substantially perpendicular to the feed rate 13. A particular feature illustrated here is that the amplitude 23 of the secondary movement 14 is altered while the feed rate 13 remains the same. At the same time, the centre position 24 of the secondary movement 14 is offset with respect to the weld line 3.

FIG. 6 illustrates a lateral movement 26 of the beam axis 2 perpendicular to the weld line 3 when forming a radial circumferential welding track 5. A second welding track 5 is produced without interruption of the relative movement immediately adjacent to the first welding track 5. An overlapping weld with a smooth transition is formed. To produce the weld seam 1 with respect to the components 7 illustrated, the laser 21 is oriented at an angle 26 with respect to the surface of the components or of the weld seam 1, i.e. rather than being perpendicular with respect thereto. This means can also be used to deliberately introduce welding energy into the components 7.

With regard to the illustrations presented in FIGS. 3, 4, 5 and 6, it should be noted that the individual configurations of the feed rate 13 and of the secondary movement 14 can be combined with one another in any desired way.

FIG. 7 reveals a drive system 12 for a four-wheel-drive vehicle 10. In this case, all four wheels 16 are driven by an engine 18. A transmission 17 can be seen in the region of the front axle and beneath the engine 11 which is also indicated. An axle transmission 17 can also be seen in the region of the rear axle. Sideshafts 15 are used to drive the wheels 16. The connection between the transmissions 17 is provided by a propshaft arrangement which comprises two shafts 19. This arrangement is additionally mounted on the underbody of the vehicle 10 by an approximately centrally arranged intermediate bearing 20. In a first propshaft portion, the propshaft arrangement has a first joint 18, arranged in the vicinity of the front transmission 17, in the form of a constant-velocity fixed joint. To connect the two propshaft portions, a second joint 18 is provided in the centre in the form of a constant-velocity fixed joint. At the end of the second propshaft portion there is a third joint 18 in the form of a constant-velocity fixed joint which is connected to the transmission 17 of the rear axle via connection means. The shafts 19 or propshaft portions in most applications rotate at a rotational speed which is above the rotational speed introduced into the manual or automatic transmission by the engine 11. The transmission ratio is stepped down in the region of the rear transmission 17 in the vicinity of the rear axle. Whereas, for example, the shafts 19 and the associated joints 18 have to execute rotational speeds of up to 10 000 revolutions per minute, the rotational speeds of the sideshafts 15 for driving the wheels are of the order of magnitude of up to 2500 revolutions per minute.

The joins according to the invention are preferably used for the following components:
propshaft system components which are joined, such as for example:
   tubular shaft/solid shaft
   tubular shaft/joint outer part
   tubular shaft/journal
   tubular shaft/joint inner part (e.g.: hub)
   joint outer part/housing cover
   joint outer part/flange—e.g. transmission flanges
   joint disc/joint base
   sliding sleeve/shaft journal
differential/transmission systems
   gear/gear
   tubular shaft/gear
   housing/housing cover
   journal/housing cover

### LIST OF DESIGNATIONS

1 Weld seam
2 Laser beam
3 Weld line
4 Subregion
5 Welding track
6 Width
7 Component
8 Join
9 Wall thickness
10 Vehicle
11 Engine
12 Drive system
13 Feed rate
14 Secondary movement
15 Sideshaft
16 Wheel
17 Transmission
18 Joint.
19 Shaft
20 Intermediate bearing
21 Laser
22 Rotation
23 Amplitude
24 Centre position
25 Lateral movement
26 Angle

1. A process for producing a weld seam in hardenable steel, comprising:
positioning a laser beam with respect to a weld line;
heating subregions of the steel by the laser beam without secondary heating, the laser beam being guided along a welding track which is longer than the weld line wherein a relative movement of the laser beam with respect to the weld line at a feed rate is generated, the relative movement having a secondary movement superimposed on it; and
cooling the heated subregions of the steel.

2-4. (canceled)
